(19) United States
(12) Patent Application Publication
(10) Pub. No.: US 2010/0094756 A1
(43) Pub. Date: Apr. 15, 2010

(54) SYSTEM AND METHOD FOR RAPID FINANCIAL TRANSACTIONS THROUGH AN OPEN FINANCIAL EXCHANGE OR WIRE TRANSFER

(75) Inventors: Benjamin Humphrey, Frisco, TX (US); Jeff Wilkinson, Frisco, TX (US); Timber Barker, Highland Village, TX (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: GelPay, LLC, McKinney, TX (US)

(21) Appl. No.: 12/576,982

(22) Filed: Oct. 9, 2009

Related U.S. Application Data
(60) Provisional application No. 61/104,552, filed on Oct. 10, 2008.

(51) Int. Cl. G06Q 40/00

(52) U.S. Cl. 705/44; 705/39

(57) ABSTRACT

A system and method for transferring funds. An electronic request for a transfer of funds between a sending account and a destination account is received. A determination is made whether the sending account and the destination account are with a destination bank controlling the destination account. The funds are transferred from the sending account to a receiving account of the service provider. The funds are transferred from a service provider account at the destination bank to the destination account in response to determining that the sending account and the destination account are not with the destination bank. A service provider is compensated for the transfer of funds and the transfers are recorded in a database in response to completion of the electronic request.

### CROSS-REFERENCE TO RELATED APPLICATION

This application claims the benefit, under 35 U.S.C. 119(e), of U.S. provisional patent application No. 61/104,552 filed on Oct. 10, 2008, the entire content of which is incorporated herein by reference.

### BACKGROUND

The use of and development of communications has grown nearly exponentially in recent years. The growth is fueled by larger networks with more reliable protocols and better communications hardware available to transaction service providers and consumers. The advancements in computing and communications have not equally translated to simpler more efficient electronic transactions. Most electronic transfers of money are still slow and may be cost prohibitive to many users.

### SUMMARY

One embodiment provides a system and method for transferring funds. An electronic request for a transfer of funds between a sending account and a destination account is received. A determination is made whether the sending account and the destination account are with a destination bank controlling the destination account. The funds are transferred from the sending account to a receiving account of the transaction service provider. The funds are transferred from a transaction service provider account of the destination bank to the destination account in response to determining that the sending account and the destination account are not with the destination bank. A transaction service provider is compensated for the transfer of funds and the transfers are recorded in a database in response to completion of the electronic request.

### BRIEF DESCRIPTION OF THE DRAWINGS

FIG. 1 is a pictorial representation of a financial transaction environment in accordance with an illustrative embodiment; and

FIG. 2 is a flowchart of a process for transferring money between a sending account and a destination account in accordance with an illustrative embodiment.

### DETAILED DESCRIPTION OF THE DRAWINGS

Illustrative embodiments provide an automated service that allows people or organizations to quickly send and receive money from a sender's bank account to a destination bank account. The illustrative embodiments may be implemented by a transaction service provider or other entity that utilizes new processes to more efficiently transfer funds. The transaction service provider may utilize one or more accounts to facilitate the transfer between the sender's account or sending party and the destination account or receiving party's account. In particular, secure servers, databases, routers, and other computing and communications elements may be utilized to initiate and carry out the transactions and perform the processes and features herein described. For example, all or portions of the processes herein described may be implemented utilizing communications, hardware, and software devices, equipment, systems, applications, and infrastructure known to those of skill in the art that are utilized by financial institutions and payment processing entities.

The transfers may occur through intra-bank transfers via internal financial institution networks, such as open financial exchange (OFX) and wire transfers. Users of the transaction service may utilize an interface to interact with transaction service provider and/or banks from a desktop personal computer, laptop, and wireless devices. The wireless devices may include a cell phone, Pocket PC, Blackberry, PDA, mp3 player, PSP, Nintendo DS, or other electronic devices suitable for wireless communications.

In one embodiment, a user or consumer may sign up for an account with the transaction service provider. The new account holder may then store important financial information, such as their name, address, bank account, routing number, bank name, bank login, and password. A username and password may be created for the user's account with the transaction service provider.

When the user elects to transfer money from their account to another account, the user may inform the transaction service provider how much money they want to send and which account the user wants to send the money to. The account may alternatively be identified by a user name, security token, or other identifier. The user request may be initiated through a telephone, website, or program executed by a client device of the user for sending and receiving data from the transaction service provider. In one embodiment, the user may communicate with the transaction service provider through a portal or application accessible from a cell phone to initiate and implement the electronic transfer. In some cases, the user may have limitations, such as maximum balance amount, transfer amount, transfer frequency, or other limitations. These limitations may be automatically or manually selected based on the history with the user, account balances, payment status, credit, capitalization, and other similar factors. In one embodiment, the limitations are stored in logic, including hardware logic and/or software logic, managed by the transaction service provider.

A login and password are requested by the transaction service provider for authentication purposes before any transaction is processed. The user may specify whether to store their bank password or have the transaction service provider prompt the user before each transaction. Any number of encryption standards or secure communications protocols may be utilized to ensure the security and privacy of the sending and receiving party, as well as stored data, such as https, SSL, and encryption (i.e., 128 or 256-bit encryption). The transaction service provider utilizes standard physical procedures, including secure locations, coded rooms, monitored and limited access, and other similar measures.

Once the transaction service provider received the user's information, the transaction service provider authenticates the user and makes sure the login and password match. If authentication fails, the transaction is denied. However, if authentication succeeds, the transaction service provider then checks to see if both bank accounts are with the same bank. If both bank accounts involved in the transaction are from the same bank, then the automated service of the transaction service provider may initiate an intra-bank transfer by integrating with the bank's network, whether by a standard OFX protocol or other method of communication automatic or otherwise. For example, the transactions may be carried out in person or over the phone by a representative of the transaction service provider. The fees, charges, percentage, implementation time, accessibility, ease of use and/or expenses charged by the transaction service provider may make such options a viable alternative. An employee may be able to make transfers between numerous accounts online or over the phone in a matter of minutes for a convenient profit to the transaction service provider. Text, video, instant, email, or other messages types, automated or manual calls, or communications may be utilized to confirm the transaction to the sending party and the receiving party (herein referred to as electronic messages).

By connecting to the bank through the OFX network, the bank may transfer the specified amount to the destination account from the sending account after the transaction service provider and bank authenticate the transaction. In one embodiment, the transaction service provider logs, records, tracks, and reconciles all requests and all electronic transfers between banks in a database dedicated for one or more customers, regions, transaction types, or other categories. The transaction service effectively uses OFX and similar account verification processes to take a summary, status, or snapshot of the user's account before and after the transaction. As a result, all fund transfers and transactions may be reconciled, audited, accounted, recorded, and otherwise logged.

The transaction service provider may have a bank account in each major bank that allows integration with an automated network, such as OFX. If the bank accounts are not from the same bank, the transaction service provider may immediately transfer funds from a bank account at the destination bank that the transaction service provider holds to the destination bank account through an automated intra-bank transfer. Since the transaction service provider covers the money immediately for the sending party, a wire transfer, or automated clearing house (ACH) transaction may be automatically created which may send money from the sender's account to a transaction service provider account. In one embodiment, the transaction service provider account that receives the covered amount may be with the bank that manages the sender's account. In another embodiment, the money may be sent through conventional transactions to a central account. A service fee may also be taken out, either immediately or at a later date.

In one example, if Sue wants to send $300, the transaction service provider may charge $0.50 for the transaction. As a result, the $300 may be moved into an account of the transaction service provider from the user's account. The remaining $299.50 may be transferred to the receiving party's account. If the user and the receiving party are with the same bank, the transaction service provider may move $299.50 directly to the receiving party's account and then do a separate transaction to move the $0.50 into the transaction service provider account. In another embodiment, the full dollar amount (i.e., $300) as well as the corresponding service fee (i.e., $0.50) may be extracted from the sending party's account and then only the specified dollar amount is transferred to the receiving party with the service fee remaining in the transaction service provider account. The transfer of the service fee may occur simultaneous with the funds transfer or may be a separate transaction. The service fee or transaction fee may vary based on the amount transferred and whether the transaction service provider have accounts with the sending bank and destination bank. The transaction fee may be a percentage (i.e. 2% or $2 for each $100 transferred), a flat fee, or a variable rate depending on a number of other factors that affect the risk taken on by the transaction service provider, complexity of the transaction, time and resource requirements and other factors. For example, transactions that require a transaction be processed by manual phone calls may be more expensive.

The illustrative embodiments provide a system and method that may be automatically implemented by the transaction service provider to transfer money from one bank account to another extremely fast. The transaction may be performed even faster than a wire transfer and may be potentially much less expensive to the user. Since intra-bank transfers are immediate because there is no money actually being moved between banks, the illustrative embodiments are much more efficient than other money transfer processes currently available. The wire or electronic transfer to reimburse the transaction service provider may take more time to complete. However, most importantly, the receiving party receives their money instantly.

Not only is the actual processing potentially just a few seconds, but the transaction may be completed extremely fast each time a user wants to send money. This is compared to the time consuming and inconvenient processing of having to go to the bank and fill out forms and manually process a wire transfer. Whenever a funds transfer occurs, the applicable user may be sent an email, text message, automated call, or other message based on the user's preferences. The messages may be sent through a secure or encrypted connection or message. The process for transferring funds from the sending account to the destination count may be particularly fast if the transaction service provider has accounts at all of the available money holding and transferring entities (i.e., banks, credit unions, exchanges, brokerages, and other common financial entities). The transaction service provider may transfer the money to the destination account at a first bank from a respective account at the first bank and receive the payment and fee from the senders account at a second bank at the transaction service provider's account at the second bank.

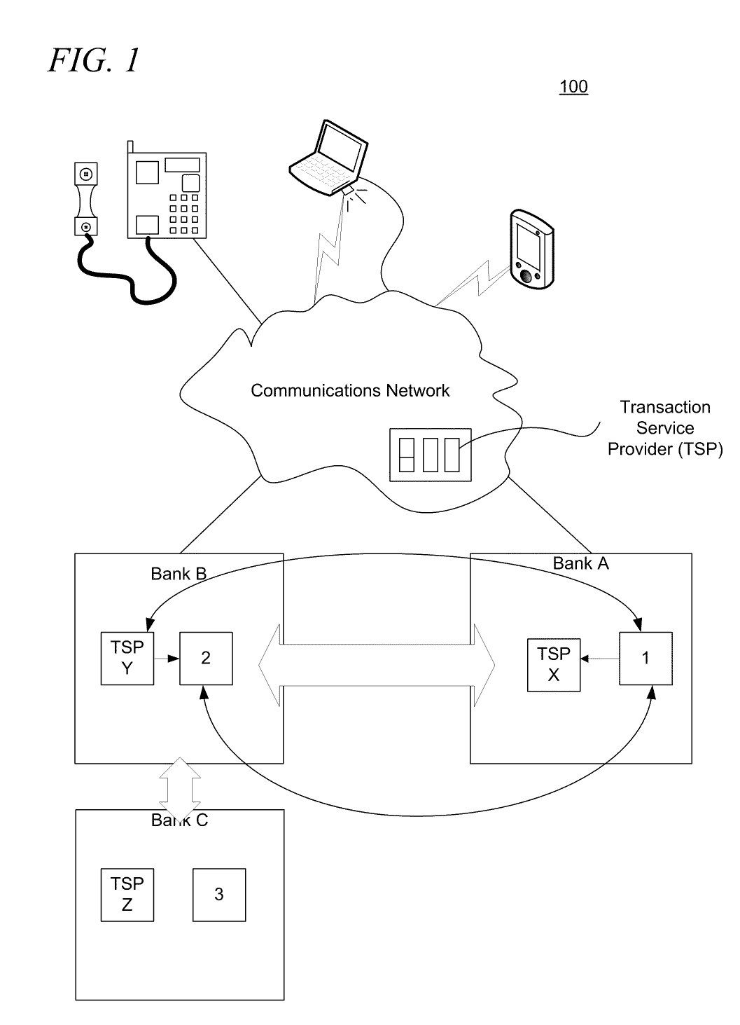

FIG. 1 is a pictorial representation of a financial transaction environment in accordance with an illustrative embodiment. FIG. 1 illustrates any number of client devices that may be utilized to initiate a transfer. The client devices may connect to one or more communications networks in communication with the transaction service provider through hard wired or wireless connections.

The transaction service provider may utilize any number of financial and transactional systems, servers, switches, routers, databases, advance intelligent network devices, modules, or other hardware and software devices and combinations to perform the processes as herein described. In one embodiment, the client devices may be utilized to access a web portal available through the transaction service provider. In another embodiment, the user may call an interactive voice response system or call service of the transaction service provider.

In yet another embodiment, the client device may house an application for communicating one or more electronic transaction requests to the transaction service provider for implementation.

In one embodiment, the user, sending account, or sending party 1 may need to send money to the receiving party or destination account 2. The transaction may occur between different banks with the sending account 1 managed by Bank A and the destination account 2 managed by Bank B.

As herein described, the transaction service provider may transfer the funds directly to the destination account 2 from a transaction service provider account Y. As a result, the destination account immediately receives the money and may almost instantaneously verify the transfer of funds. As a result, the receiving party is very satisfied with the transaction services and payment from the sending party inspiring confidence and further transactions services or transfers.

Subsequently, the funds are transferred from the sending account 1 to another account utilized by the transaction service provider X. Alternatively, for accounting purposes the transaction service provider may have the sending account 1 transfer the funds to the transaction service provider account Y or the funds may be transferred from the sending account 1 to the transaction service provider account X first to ensure that the funds are available before then sending the funds from the transaction service provider account X to the transaction service provider account Y.

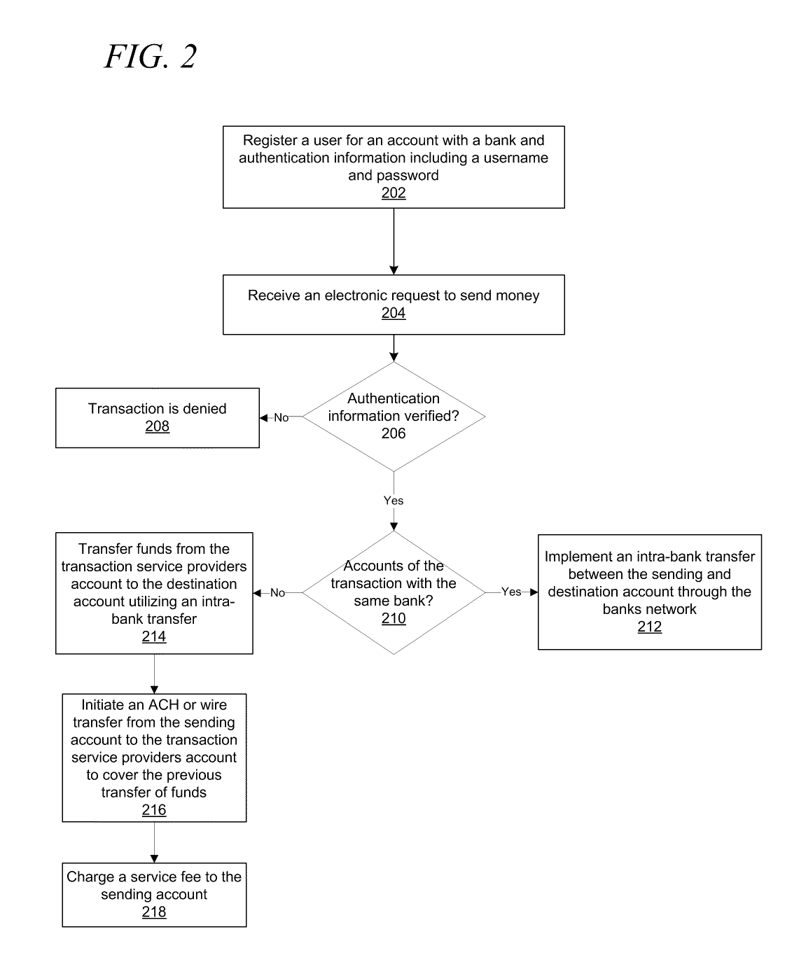

FIG. 2 is a flowchart of a process for transferring money between a sending account and a destination account in accordance with an illustrative embodiment. The process of FIG. 2 may be implemented by a client device, a transaction service provider, and one or more banks. The process may begin by registering a user for an account with a bank and authentication information including a username and password (step 202). The authentication information includes any number of other identifiers, including biometrics, identifiers, or other authentication information.

Next, the transaction service provider receives an electronic request to send money (step 204). The electronic request may be in the form of user input. The user input may be in the form of text message, instant message, email, voice commands, data, or other information. The request may be generated to make it appear as if the sender is transferring money from the sending account to a receiving party or destination account even if the process is as shown and described herein. The electronic request may be initiated through a web portal operated by the transaction service provider. The electronic request may also be initiated utilizing an application installed on a client device, such as a laptop, cell phone, PDA, or other similar computing or communications device. In one embodiment, a specialized card reader configured to communicate with a wireless device, such as a cell phone, may initiate the request. For example, a landscaping company may tell a customer of a weekly expense and the customer may seek to send an electronic payment to the lawn service.

Next, the transaction service provider determines whether the authentication information is verified (step 206). The authentication information may be included in the electronic request of step 204. If the authentication information is not verified, the transaction is denied. The authentication information is denied to prevent an unauthorized user from carrying out a transaction. In one embodiment, the authentication of step 206 may determine whether the sending account has sufficient funds to complete the transaction. A status inquiry may be implemented or a transfer from the sending account to an account of the transaction service provider's account may be simulated or carried out. If there are insufficient funds, the transaction is denied (step 208) because the funds do not cover the request and corresponding fee charged by the transaction service provider.

If the authentication information is verified in step 206, the transaction service provider determines whether the accounts of the transaction are with the same bank (step 210). If the accounts are with the same bank, the transaction service provider implements an intra-bank transfer between the sending and destination account through the banks network (step 212).

If the accounts of the transaction are not within the same bank in step 210, the transaction service provider transfers funds from the transaction service provider account to the destination account utilizing an intra-bank transfer (step 214). In one embodiment, the transaction service provider may have accounts in many or all of the large, mid-sized, and small banks, credit unions and financial institutions that may be utilized by the user. In one embodiment, the transaction service provider may suggest that the user sign up for an account with one or more specified banks to be able to carry on the transactions as herein described.

Next, the transaction service provider initiates an ACH or wire transfer from the sending account to the transaction service provider account to cover the previous transfer of funds (step 216). The transfer from the sending party's account to the transaction service provider covers the money that is transferred to the destination account. In one embodiment, step 216 may be performed before step 214 in order to ensure that the transaction service provider is able to make the transfer and protects the money and security of the transaction service provider. In another embodiment, the transaction service provider may utilize any number of guarantees or systems to ensure that the transaction service provider receives compensation regardless of the timing of the transfer of step 216. The sending party may be required to provide alternative payment methods that are charged in response to insufficient funds or other errors. For example, credit cards, debit cards, alternative accounts, or other payments services may be utilized as a back up. Other current or future transfer standards, protocols or types may also be utilized to initiate and perform the transfers herein described.

Next, the transaction service provider charges a service fee to the sending account (step 218). In one embodiment, the service fee may be included in the transfer of step 216. In another embodiment, the charges for a time period, such as each month, may be billed to the sending account at a single time or automatically withdrawn from an account, credit card, or other available funds.

In one embodiment, the transactions herein described may be implemented utilizing servers and transaction systems currently available. The server or systems may execute a program or utilize logic (hardware, software, or a combination thereof) to implement the processes, steps, algorithms, and methods herein described.

The previous detailed description is of a small number of embodiments for implementing the invention and is not intended to be limiting in scope. The following claims set forth a number of the embodiments of the invention disclosed with greater particularity.

1. A method for transferring funds, the method comprising:
receiving an electronic request for a transfer of funds between a sending account and a destination account;
determining whether the sending account and the destination account are with a destination bank controlling the destination account;
transferring the funds from the sending account to a receiving account of a transaction service provider;
transferring the funds from a transaction service provider account at the destination bank to the destination account in response to determining that the sending account and the destination account are not with the destination bank;
compensating the transaction service provider for the transfer of funds in response to completion of the electronic request; and
recording the transfers in a database in response to the completion of the electronic request.

2. The method of claim 1, wherein the electronic request is received through a telephone portal, a web portal, or an interface with an application.

3. The method of claim 1, further comprising:
determining whether the funds are available in the sending account;
terminating the electronic request in response to determining the funds are not available; and
performing the transferring of the funds from the sending account to a receiving account of the transaction service provider in response to determining the funds are available.

4. The method of claim 1, wherein the compensating further comprises:
transferring a service fee to the transaction service provider.

5. The method of claim 4, wherein the funds include the service fee.

6. The method of claim 1, wherein the compensating is performed during the transferring the funds from the sending account to the transaction service provider account.

7. The method of claim 1, wherein the compensating is performed as a separate transfer from the sending account to the transaction service provider account.

8. The method of claim 1, further comprising:
authenticating a user associated with the sending account is authorized to initiate the electronic request;
limiting the electronic request utilizing logic managed by the transaction service provider;
performing the transactions and communications utilizing encrypted communications; and
confirming the completion of the electronic request by an electronic message.

9. The method of claim 1, further comprising:
transferring the funds directly from the sending account to the destination account in response to determining the sending account and the destination account are within a same bank, wherein the compensating is performed by transferring a fee of the transaction service provider to the receiving account.

10. The method of claim 1, further comprising:
selecting the receiving account from a plurality of receiving accounts in response to a determination of a sending bank managing the sending account, wherein each of the plurality of receiving accounts being at a different bank.

11. The method of claim 10, further comprising:
establishing each of the plurality of receiving accounts at each of a plurality of banks, the plurality of banks being any number or type of financial institutions; and
utilizing communications implemented by individuals employed by the transaction service provider for sending money to a financial institution not include in the plurality of banks.

12. The method of claim 1, wherein the funds are transferred utilizing OFX, ACH, or wire transfers.

13. A system for transferring funds, the system comprising;
a client in communication with a communications network, the client being operable to send an electronic request for a transfer of funds between a sending account and a destination account;
a plurality of financial institutions in communication with the communications network including a destination bank;
a transaction service provider in communication with the client and the plurality of financial institutions through the communications network, wherein the transaction service provider is operable to determine whether the funds are available in the sending account, determine whether the sending account and the destination account are with the destination bank controlling the destination account, transfer the funds from the sending account to a receiving account of the transaction service provider in response to a determination the funds are available, transfer the funds from a transaction service provider account at the destination bank to the destination account in response to a determination that the sending account and the destination account are not with the destination bank, and compensate the transaction service provider for the transfer of funds with a transaction fee in response to completion of the electronic request; and
a database for recording the transfers in response to the completion of the electronic request.

14. The system of claim 13, wherein the transaction service provider communicates with secure servers to perform the transfers within the plurality of financial providers.

15. (canceled)

16. The system of claim 13, wherein the transaction service provider selects the receiving account from a plurality of receiving accounts in response to a determination of a sending bank managing the sending account, each of the plurality of receiving accounts being at a different bank.

17. (canceled)

18. The system of claim 13, wherein the transfers are performed by commands sent by the transaction service provider to secure servers operated by the plurality of banks, the transfers are performed utilizing OFX transfers or ACH transfers.

19. The system of claim 13, wherein the transaction fee is sent to a central account of the transaction service provider.

20. The system of claim 17, wherein the funds include the transaction fee, wherein the transaction fee is separated from the funds before being transferred to the destination account.

21. The system of claim 13, wherein the transaction service provider includes a plurality of users managing electronic requests and the transfers associated with the electronic requests for financial institutions with which the transaction service provider does not have accounts.

22. The system of claim 13, wherein the funds are transferred directly from the sending account to the destination account in response to a determination that the sending account and the destination account are within a same bank, wherein the compensating is performed by transferring a fee of the transaction service provider to the receiving account.
